(19) United States
(12) Patent Application Publication
(10) Pub. No.: US 2012/0114811 A1
(43) Pub. Date: May 10, 2012

(54) Citrus paper application sheet for applying to freshly exposed or cut surfaces of fruit to prevent browning

(76) Inventor: Kathleen Abigail Lappe, Bowling Green, KY (US)

(21) Appl. No.: 13/317,981

(22) Filed: Nov. 1, 2011

Related U.S. Application Data
(63) Continuation-in-part of application No. 11/209,488, filed on Aug. 23, 2005, now abandoned.
Application No. 11/209,488 is a continuation-in-part of application No. 10/356,212, filed on Jan. 31, 2003, now abandoned.

(51) Int. Cl. B65D 81/28; A23B 7/154

(52) U.S. Cl. 426/133; 426/323; 426/270

(57) ABSTRACT

A citrus paper application sheet treated with natural preservatives for application to exposed or cut surfaces of fruit to prevent oxidation and browning. The sheet is designed to adhere and conform to the shape of the exposed portion of the fruit once dampened and dry retaining the conformed shape. The sheet is further designed to enable it to be dispensed in selected lengths and widths or particular dimensions depending upon the fruit application further enabling the sheets to be moistened and sculpted to a desirable shape to conform to that of the exposed fruit.

### CROSS-REFERENCE TO RELATED APPLICATION

This application claims priority from and is a continuation in part of application Ser. No. 11/209,488 filed on Aug. 23, 2004 which claims priority from U.S. application Ser. No. 10/356,212 filed on Jan. 31, 2003 both of which are incorporated herein in their entirety.

### FIELD OF THE INVENTION

The field of this invention relates to a method of preserving fresh fruit or vegetables which discolor, lose flavor and/or nutrients after cutting, as well as, create a much needed barrier against any unwanted matter, such as bugs, dirt or pathogens from invading the freshly exposed or cut portion of fruit or vegetable and is intended to be an end-used product or household product to be used as needed.

### BACKGROUND OF THE INVENTION

The average family's yearly consumption of food often results in large quantities of wasted edible fruit. When half of a banana or part of an apple is eaten, browning usually occurs on the uneaten portion, which is often times then discarded. Currently, there is no method known in the art or option for the consumer to preserve and protect their cut fruit at home. In addition, the convenience of having ready-made preservative paper strips on hand in an easily accessible distribution box, to apply immediately apply on the uneaten exposed parts of fruit to prevent browning and to protect it from unwanted matter, such as bugs, dirt or pathogens, is an extremely valuable product that has not yet been introduced to the public.

ABSTRACTED-PUB-NO: DE 3717862A, Inventor: Stephan J. discloses the fresh fruit salads—comprised of fruit cubes treated with fruit juice in an airtight package. Although the bagged preserved fruit may be effective. The long term usability is not convenient, as it must be consumed in a timely manner as the fruit is already cut. Also, vacuum packaging generally creates an-aerobic conditions which are conductive fermentation, often resulting in distorted flavors and promote growth of pathogenic organisms.

Japanese patent abstract publication: 10-113120, Inventor: Mishima Toshihiro, discloses the use of sulfates, which are a combination of sulfur compounds that combine sulfur with amino acid, sulfate, sulfite, and thioshifate. Sulfates are known to cause adverse health effects, especially in asthmatics. They can also negatively affect the taste of food. FDA prohibits the use of sulfites on fresh produce intended to be sold or served raw to consumers, and because sulfites destroy thiamin (vitamin B1), the FDA also prohibits the use of sulfites in foods that are important sources of this nutrient, such as enriched flour. Also, the paper or various kinds of web material mentioned are limited and fail to list a specific formula as to what specific type of paper would be effective.

JP402291226A describes a technique of coating cutlery, a wrapping sheet to the exposed portions of fruit with an edible jelly material. This composition suffers from the disadvantage of having a slippery or slimy texture. It may be acceptable for salads which are covered in fruit juice but not for fruit intended to be eaten with fingers rather than a spoon. Also, the wrapping sheet mentioned is limited, by having no specific formula as to what specific type of paper would he effective.

JP409077603 describes the use of Kojic acid [5-hydroxy-2-(hydroxyme-thyl)-gamma-pyrone], a fungal metabolite that has been shown to be a PPO inhibitor, acting by interfering with oxygen uptake and reducing o-quinones to diphenols to prevent pigment formation (Chen et al., 1991). Whether this compound shows potential as a practical browning, kojic acid is a fungal metabolite commonly produced by many species of aspergillus, acetobacter and penicillium. The aspergillus flavus group has traditionally been used in the production o fa number o f foods, including miso (soybean paste), shoyu (soy sauce), and sake. Kojic acid is widely used as a food additive for preventing enzymatic browning and in cosmetic preparations as a skin-lightening or bleaching agent. Because kojic acid is often produced during the fermentation of historically used dietary staples, it has a long history of consumption. Various types of compounds, such as glucose, sucrose, acetate, ethanol, arabinose and xylose, have been used as carbon sources for kojic acid production. Different aspergillus species are known to produce variable amounts of kojic acid. The mechanism of action of kojic acid is well defined and has been shown to act as a competitive and reversible inhibitor of animal and plant polyphenol oxidases, xanthine oxidase, D-amino and some L-amino acid oxidases. The structure of kojic acid indicates a relatively simple route of metabolism much like dietary hexoses. Acute or sub chronic toxicity resulting from an oral dose has not been reported, but convulsions may occur if kojic acid is injected. Results of mutagenicity studies are mixed, but in the in vivo mammalian dominant lethal assay, kojic acid was proven negative. Continuous administration of high doses of kojic acid in mice resulted in induction of thyroid adenomas in both sexes. Kojic acid reversibly affects thyroid function primarily by inhibiting iodine uptake, leading to decreases in T3 and T4 and increase in TSH. Increased TSH from pituitary gland in turn stimulates thyroid hyperplasia. Several lines of evidence indicate that the proliferative effects of kojic acid on thyroid are not related to a genotoxic pathway. The risk of functional inhibition of iodine uptake and its metabolism (organification) and thyroid tumor induction by kojic acid in humans appears to be extremely low. Based on the literature reviewed and discussed here, consumption of kojic acid at levels normally found in food does not present a concern for safety. Copyright 2001 Academic Press.

The Kojic acid normally used in cosmetics would seem to be undesirable in its limited FDA research and current finding to the consumer for consumption. Also, the water absorbent paper of non-woven fabric mentioned is limited to having no specific formula as to what specific type of paper would be effective.

### SUMMARY OF THE INVENTION

The present invention provides a citrus paper application Sheet for applying to exposed or cut surfaces of fruit to prevent browning. The sheet is designed to adhere to the fruit once dampened. The sheet is further designed to enable it to be measured and cut to particular lengths and widths, so that it duplicates the precise functioning of whatever particular length and width is preferred for application.

One preferred embodiment of the present invention comprises, consist essentially of or consists of a preservative paper dispenser kit having a paper dispenser; a sheet of acid-free paper weighing between 90 to 150 grams per square meter; the paper including of a receiver selected from micro-particles, gelatin, or polymer. The paper has a barrier selected from polyethylene, cast coating, and a wash coating The paper includes a base of cellulose or a film. The paper is immersed in a solution containing from 8 to 10 parts concentrate and 1 part water and dried and cut into strips of selected dimensions. Upon damping and application to a freshly exposed surface of a fruit the paper forms a barrier limiting exposure of the surface of the fruit to less than 3% oxygen preventing browning of the exposed surface of the fruit. The preservative paper can be an uncoated or coated paper depending upon the application. Moreover, a chemical preservative such as a sufficient amount of sodium sulfite, sodium metabisulfite, and a sodium benzoate can be added to the paper to prevent deterioration.

Preservative strips describe during manufacturing, must be put in sufficient acid constituents solution of citric acid and/or ascorbic acid for more than five (5) minutes or longer for proper permeation. After soaking in the acid constituents solution for more than five (5) minutes, the preservative strips are then removed, dried and cut into the specific sizes and packaged for shelving or sale. The preservative paper can than be applied to any uneaten portion of fruit or vegetable to preserve, keep from browning and protect for future consumption, therefore reducing large quantities of wasted fruit and protecting the consumers health, as well as, saving the consumer money.

With a shelf-life of over a year, this product is also inexpensive to manufacture, making it much more cost effective for the general consumer, a person that can only afford to buy whole fruit as opposed to the high-priced pre-cut bagged preservative fruit.

The preservative paper strips, on the other hand, can be used on an as-needed basis and does not require refrigeration after application. The preservative strips are also extremely effective/on cut end fingers of bananas and last the life of the banana.

In one preferred embodiment, the specific paper type consisting of 25-40 lb wt. or 90-150 grams per sq. meter, uncoated, acid-free, laser printing paper, with bond strength of an interlayer binding force is the key to achieving the desired results. A lighter paper, such as below 25 lb bond paper, toilet paper, paper towel or woven fabric would be too fragile and/or porous. A heavier paper, such as above 40 lb bond paper, heavy card stock paper and card board would be too hard and/or stiff The specific preservative strip of 25-40 lb wt. or 90-150 grams per sq. meter, described above, is as close to putting the skin back on the fruit as is possible without actually doing so.

The preservative paper of weighting 25-40 lbs or 90-150 grams per sq. meter uncoated, acid-free, laser printing paper, with bond strength of an interlayer binding force, is soaked for at least live (5) minutes in sufficient acid constituents, then dried for at least one (1) hour prior to use for applying to exposed or cut surfaces of fruit or vegetables that discolor, lose flavor and/or nutrients after cutting, as well as, create a much needed barrier against any unwanted matter, such as bugs, dirt or pathogens from invading the freshly exposed or cut portion of fruit or vegetable and is intended to be an end-user product or household product to be used at home as needed.

The preservative agents; sodium benzoate, sodium metabisulfite and sodium sulfite arc a necessary addition for the shelf life of the acid constituents before the manufacturing process. The removal of the micro-biocides process from the paper is necessary to make the paper food grade.

In a second preferred embodiment, The paper application is comprised of a citric juice concentrate or ascorbic acid (vitamin C), purified water, and coated paper. The coated paper is immersed in the citric juice concentrate, water, or ascorbic acid, water, then dried and cut into the citrus paper application sheets. The applying effected by the instant invention is particularly designed to prevent browning of the freshly exposed or cut surface of fruit over which it is applied.

It is desirable for an exposed or cut section of fruit to not brown. Accordingly, a sheet of citric based, or ascorbic acid based, coated paper, dampened then applied to the fruit, is capable of providing a barrier that prevents browning.

The preferred method of application is for the sheet to be dampened under running water then applied directly to freshly exposed or cut part of fruit.

For best results; after application, keep all fruit, except bananas, in refrigerator.

More particularly, a method of preserving an exposed surface of fruit with a preservative paper, consists of, consists essentially of, or comprises the steps of preparing a preservative paper by selecting a sheet of paper weighting between 20 to80 pounds and more preferably between 25 to 40 pounds. A receiver is selected from micro-particles, gelatin, and polymer and applied to the paper. A barrier is selected from polyethylene, cast coating, and a wash coating and applied to the paper. A base is selected from the group consisting of cellulose and a film and applied to the paper. The paper is immersed in citric juice and water concentrate or a citric acid and water concentrate producing a preservative paper which is dried for packaging or storage for later application. The desired strip of quantity of preservative paper can be pulled from a tape, roll, or sheet of material disposed in a disposable packet and applied to an exposed portion of a piece of fruit by dampening and moistening the dried preservative paper with water forming a moistened preservative paper for application to the freshly exposed surface of the fruit shaping the preservative paper conforming same to the shape of the exposed portion of the fruit. The paper covering the fruit is then redried forming a barrier limiting exposure of the surface of the fruit to less than 3% oxygen preventing browning of the exposed surface.

It is an objective to use a paper having a weight of between 90-150 grams, about 25 to 40 pounds because a lighter paper will not absorb the effective amount of acid solution and heavier paper will not conform to the fruit shape when dampened to effectively seal the exposed portion of the fruit from air.

It is another objective to use of 100% citric juice concentrate and, water or 100% ascorbic acid (vitamin C) and, water for providing a non-browning agent where as, the basic coated paper for this invention adheres as it dries creating a barrier preventing less then 3% oxygen. Thus, allowing the citric juice concentrate or ascorbic acid to prevent browning long term.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 shows application of the preservative paper in selected shapes as applied and conforming to exposed pulp surface portions of an apple to prevent oxidation and browning; and

FIG. 2 shows application of the preservative paper in selected shapes as applied to conform to exposed pulp surface portions of a banana to prevent browning.

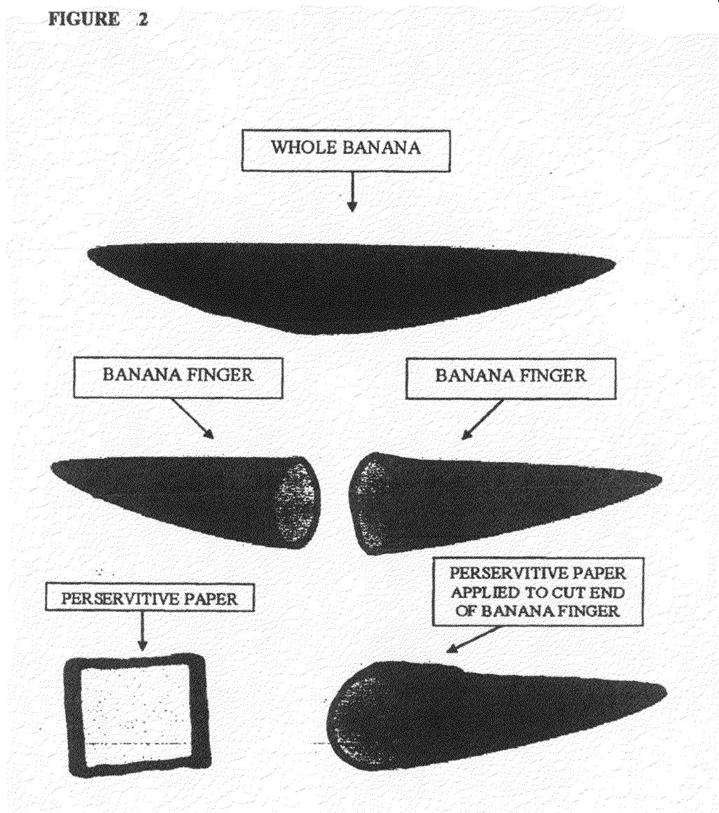

### DETAILED DESCRIPTION OF THE INVENTION

The present invention provides a composition and method of preparation of the preservative paper utilizing a selected acid concentration soaked for a specific time period and dried to be used later after wetting in order to shape the preservative paper to the desired shape to effectively seal the surface of the exposed food from air.

### Coated Paper Embodiments

One embodiment of the present invention provides for a method of preventing browning of exposed fruit by applying the coated citrus paper application sheet with water directly to the freshly exposed or cut fruit. The coated citrus paper application sheet comprises a sheet of 20-801b, smooth, coated paper (commonly found, at any retail store carrying paper products) in lengths of 1″ to 500″, in widths of 1″ to 500″, in a solid white brilliance of 84-96 treated with 100% citric juice concentrate and (purified) water (commonly found, at any grocery store in the freezer section or shell) with proportions of 400 GPL (grams per liter), in a ratio range of eight parts 100% citric juice concentrate to one part purified water.

The method of preventing browning of exposed fruit is accomplished by applying the coated citrus paper application sheet with water directly to the freshly exposed or cut fruit, wherein the citrus paper sheet comprises a sheet of 20-80 lb, smooth, coated paper (commonly found, at any retail store carrying laser, jet or copy paper) in lengths of 1″ to 500″, in widths of 1″ to 500″, in a solid white brilliance of 84-96 treated with 100% ascorbic acid (vitamin C), and (purified) water with a ratio range of ten parts 100% ascorbic acid (vitamin C) to one part purified water.

The ratio range of the 100% citrus juice concentrate or the ascorbic acid to water, can be slightly modified for exactly the same or similar results desired for preventing browning. The coated paper sheet cut in lengths of 1″ to 500″, and in widths of 1″ to 500″ can be measured and cut into shorter, customized-lengths and widths. The most preferred lengths and widths range in lengths of 1″ to 12″ and in widths of 1″ to 12″. The coated paper comes in a variety of different standard colors.

The basic 100% citric juice concentrate is comprised from five citrus groups: orange, lemon, lime, grapefruit, and mandarin/tangerine.

The anti-browning agent can comprise 100% citric juice concentrate and water, with the proportions being: 400 GPL (grams per liter), a ratio of seven parts 100% citric juice concentrate to one part water. The anti-browning agent can also comprise 100% ascorbic acid (vitamin C) and water with a proportion ratio range of one part 100% ascorbic acid and up to ten parts water.

Optionally, a preservative agent such as sodium bisulfite, and sodium benzoate, may be included in accordance with the proportions regulated by the FDA (Food and Drug Administrative) based on pounds per 1000 gallon batch.

A preferred coated paper embodiment of the basic coated paper structure is comprised of four layers: a receiver-made from micro-particles, gelatin, or polymer; a barrier-made from polythene, cast coating, or wash coating; a base-made from cellulose or film; and optionally a backing-made from various plastics.

In another preferred coated paper embodiment, the basic coated paper defines band paper, fine paper, ink jet paper, laser paper, copy paper, or cover paper.

### Uncoated Paper Embodiments

This invention will now be described with reference to the following tests. These tests should not be assumed to limit the claims of this invention.

The object of this experiment was to determine the importance of specifying a paper type to be used in the invention, and that generalization is not acceptable. The specific type as specified in the invention for the preservative paper is a weight of 25-40 lbs or 90-150 grams per sq. meter uncoated, acid-free, laser printing paper, with bond strength of an interlayer binding force, combined with sufficient acid constituents.

Table 1.3 and 1.5-8″ by 11.5″ sheets of paper soaked in a tray of one-hundred percent (100%) lemon citric juice and preservative agents; sodium benzoate, sodium metabisulfite and sodium sulfite for five (5) minutes, then removed and placed on a drying rack till dry.

Table 1.4 and 1.6-8″ by 11.5″ sheets of paper soaked in a tray of, one-hundred percent (100%) lemon citric juice and preservative agents; sodium benzoate, sodium metabisulfite and sodium sulfite for fifteen (15) minutes, then removed and placed on a drying rack till dry.

Table 1.6 Other paper (sizes varied upon what was available) soaked in a tray of, one-hundred percent (100%) lemon citric juice and preservative agents; sodium benzoate, sodium metabisulfite and sodium sulfite for fifteen (15) minutes, then removed and placed on a drying rack till dry.

Once all the papers were dry, they were cut into three (3) inch squares for apples and two (2) inch squares for bananas.

scoring system described in Table 1.1 was used to subjectively assess the visual acceptability of fresh cut apple pieces. End of use life corresponds with a visual score of five (5).

TABLE 1.1

| SCORE | Definition |
|---|---|
| 0-1 | No browning. |
| 2-3 | Slight loss of color, no browning. |
| 3-4 | Slight browning, slight drying appearance. |
| 4-6 | Medium browning, also dry appearance. |
| 6-7 | ⅔ browned, also dry appearance. |
| 8-9 | ¾ of the whole browned, also dry appearance. |
| 10 | Whole piece browned. |

Table 1.2 was used to access the incidentals that affect the overall test types such as; (ta)—Unable to prevent Tearing during Application; indicating that the paper in use is to fragile, (tm)—unable to prevent Tearing during Manufacturing; indicating that the paper in use is to fragile for the manufacturing, (s)—unable to remove Stuck; indication that the paper sticks to the fruit making it uneatable, (fe)—unable to keep on fruit Fell off; the paper is too stiff unable to bend or adhere for proper use, (u)—ugly, manufacturing process significantly changed the paper's facade; the paper has turned brown, rippled or bubbled, NA—not able to test; specifically for the card board, it was too stiff and thick to adhere properly to the apples and immediately fell off, failing the test before it had a chance to begin, (A)—Acceptable, score is under five (5), and (U)—Unacceptable, score is five (5) or greater.

TABLE 1.2
SYMBOLS

(ta) = unable to prevent tearing during application.
(tm) = unable to prevent tearing during manufacturing.
(s) = unable to remove, stuck to fruit.
(fe) = unable to keep on fruit, fell off.
(u) = ugly, manufacturing process significantly changed the paper's
fa.cedilla.ade.
(A) = Acceptable, score is under five (5).
(U) = Unacceptable, score is five (5) or greater.
NA = Not able to test.

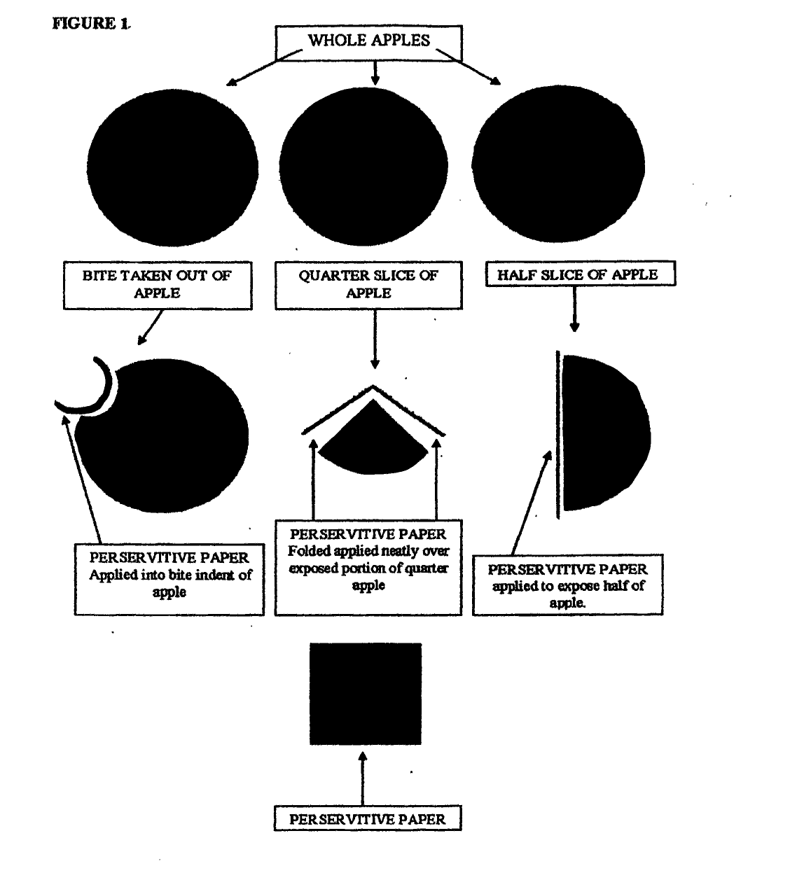

Apples (red delicious and granny smith) in tables 1.3 and 1.4 were sliced longitudinally into four (4) quarters. Since there was a total of thirteen (13) different test types, each test type was allotted one (1) quarter red delicious and one (1) quarter granny smith. See FIG. 1.1.

Bananas in table 1.5 and 1.6 were sliced in half making two fingers. Since there was a total of thirteen (13) different test types, each test type was allotted one (1) finger per test type. See FIG. 1.2.

The dry preservative papers cut into three (3) inch squares, were quickly dampened then applied to the allotted apple quarters and banana finger ends, then placed on a specified plate labeled by test type and soak time, in a line on a table for timed observation. The room temperature was on a controlled seventy-three (73) degrees with moderate humidity, normal in any given household.

### Results and Discussion

Table 1.3 below summarizes the resultant scores of the fresh cut apple samples subjected to the various test types of paper previously soaked during manufacturing for five (5) minutes only, giving results over an eighteen (18) hour time lap. The result scale of four and a half (4.5) or greater can be considered unacceptable as marked with the symbols (AU) OR (U). The result scale of four (4) or less can be considered acceptable as marked with the symbol (A).

TABLE 1.3
Apples
Soaked for five (5) minutes during manufacturing

| BOND PAPER - test type | 1:30 pm | 3:30 pm | 5:30 pm | 7:30 pm | 930 pm | 9:30 am |
|---|---|---|---|---|---|---|
| 25 lb Premium laser | 0 Scale | 1 (A) | 1.5 (A) | 3 (A) | 5 (U) | 7 (U) |
| 32 lb Laser jet | 0 | 5 (A) | 1 (A) | 1.5 (A) | 3 (U) | 4 (A) |
| 21 lb Multi-purpose | 0 | 1.5 (A) | 3.5 (A) | 5 (U) | 7 (U) | 7 (U) |
| 20 lb Food-grade standard (tm) | 0 | 2 (A) | 4 (A) | 6 (U) | 7 (U) | 8 (U) |

Table 1.4 below summarizes the resultant scores of the fresh cut apple samples subjected to the various test types of paper previously soaked during manufacturing for fifteen (15) minutes only, giving results over an eighteen (18) hour time lap. The result scale of four and a half (4.5) or greater can be considered unacceptable as marked with the symbols (AU) OR (U). The result scale of four (4) or less can be considered acceptable as marked with the symbol (A).

Table 1.4 shows a marked improvement from table 1.3 from unacceptable to acceptable, the only difference between the tests being the soak time during the manufacturing process, which was increased by ten (10) minutes.

TABLE 1.4
Apples
Soaked for fifteen (15) minutes during manufacturing

| | 1:30 pm | 3:30 pm | 5:30 pm | 7:30 pm | 9:30 pm | 9:30 am |
|---|---|---|---|---|---|---|
| BOND PAPER-test type | | | | | | |
| lb Premium laser | 0 Scale | .5(A) | 1(A) | 2(A) | 3(A) | 4(A) |
| 32 lb LaserJet, bond | 0 | .5(A) | 1(A) | 2(A) | 2(A) | 3(A) |
| 21 lb Multi-purpose | 0 | 1(A) | 2(A) | 2.5(A) | 3(A) | 4(A) |
| 20 lb Food-grade, standard (tm) | 0 | 1(A) | 2(A) | 3(A) | 5(U) | 6(U) |
| OTHER TYPES OF PAPER | | | | | | |
| Toilet paper, Nice n' Soft (tm, u) | 0 Scale | 4(A) | 7(U) | 8.5(U) | 9.5(U) | 10(U)(s) |
| Card stock, premium (tm, u) | 0 | 3(A) | 5(U) | 6(U) | 7(U) | 8(U) |
| HANDI-WIPE-web woven fabric (u) | 0 | 2(A) | 5(U) | 8(U) | 9(U) | 10(U) |
| Paper towel, Brawny (u) | 0 | 2(A) | 4.5(AU) | 7(U) | 9(U) | 9(U) |
| Card board, backing (fe) | 0 | NA | — | — | — | — |

Table 1.5 below summarizes the resultant scores of the fresh banana fingers samples subjected to the various test types of paper previously soaked during manufacturing for five (5) minutes only, giving results over an eighteen (18) hour time lap. The result scale of four and a half (4.5) or greater can be considered unacceptable as marked with the symbols (AU) OR (U). The result scale of four (4) or less can be considered acceptable as marked with the symbol (A).

TABLE 1.5
Bananas
Soaked for five (5) minutes during manufacturing

| BOND PAPER | 1:30 pm | 3:30 pm | 5:30 pm | 7:30 pm | 9:30 pm | 9:30 am |
|---|---|---|---|---|---|---|
| 25 lb Premium laser | 0 Scale | 1 (A) | 1.5 (A) | 2 (A) | 3 (A) | 4 (A) |
| 32 lb LaserJet, bond | 0 | .5 (A) | .5 (A) | 1 (A) | 1 (A) | 2 (A) |
| 21 lb Multi-purpose | 0 | 3 (A) | 4 (A) | 4.5 (AU) | 5 (U) | 6 (U) |
| 20 lb Food-grade, standard (tm) | 0 | 3 (A) | 4.5 (AU) | 5 (U) | 5.5 (U) | 7 (U) |

Table 1.6 below summarizes the resultant scores of the fresh banana lingers samples subjected to the various test types of paper previously soaked during manufacturing for fifteen (15) minutes only, giving results over an 18 hour time lap. The result scale of four and a half (4.5) or greater can be considered unacceptable as marked with the symbols (AU) OR (U). The result scale of four (4) or less can be considered acceptable as marked with the symbol (A).

Table 1.6 shows a marked improvement from Table 1.5 from unacceptable to acceptable, the only difference between the tests being the soak time during the manufacturing process, which was increased by ten (10) minutes.

TABLE 1.6
Bananas
Soaked for fifteen (15) minutes during manufacturing

| | 1:30 pm | 3:30 pm | 5:30 pm | 7:30 pm | 9:30 pm | 9:30 am |
|---|---|---|---|---|---|---|
| BOND PAPER | | | | | | |
| 25 lb Premium laser | 0 Scale | 1(A) | 1(A) | 2(A) | 2(A) | 3(A) |
| 32 lb Laser jet | 0 | .5(A) | 1(A) | 1(A) | 1(A) | 2(A) |
| 21 lb Multi-purpose | 0 | 1(A) | 2(A) | 3(A) | 4(A) | 4.5(AU) |
| 20 lb Food-grade, standard (tm) | 0 | 1.5(A) | 2(A) | 3(A) | 4(A) | 5(U) |
| OTHER TYPES OF PAPER | | | | | | |
| Toilet paper, Nice n' Soft (tm, u) | 0 Scale | 4(A) | 7(U) | 8(U) | 8(U) | 9(U) |
| Card stock, premium (tm, u) | 0 | 3(A) | 4(A) | 6(U) | 7(U) | 8(U) |
| HANDI-WIPE-web woven fabric (u) | 0 | 3(A) | 5(U) | 6(U) | 7(U) | 8(U) |
| Paper towel, Brawny (u) | 0 | 2(A) | 4(A) | 5(U) | 6(U) | 7(U) |
| Card board, backing (fe) | 0 | NA | — | — | — | — |

Table 1.4 and 1.6 show distinct differences in capabilities of different paper types and proves that paper cannot be generalized as just paper it must be stated as to what specific type, for example: unable to prevent tearing during application, unable to prevent tearing during manufacturing, unable to remove, stuck to fruit, unable to keep on fruit, fell off, ugly appearance, and manufacturing process significantly changed the paper's facade. Specific to this invention, acceptable score results fell best within the 32 lb range. Concluding that for the specifics of this invention a preservative paper of wt 25-40 lb or 90-150 grams per sq. meter uncoated, acid-free, laser printing paper, with bond strength of an interlayer binding force, soaked in acid constituents, for at least fifteen (15) minutes and then dried for at least one (1) hour prior to use for applying to exposed or cut surfaces of fruit or vegetables is a necessary formula and that the paper type is not an obvious choice and cannot be described as just “paper.”

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplifications presented herein above. Rather, what is intended to be covered is within the spirit and scope of the appended claims.

I claim:

1. A preservative paper consisting essentially of:
a sheet of paper weighing between 20 to 80 pounds;
said paper including a receiver selected from the group consisting of micro-particles, gelatin, or polymer;
said paper includes a barrier selected from the group consisting of polyethylene, cast coating, and a wash coating;
said paper includes a base selected from the group consisting of cellulose and a film;
said paper being immersed in citric juice and water concentrate or ascorbic acid concentrate;
said paper being dried and cut into dry application sheets of selected dimensions for application;
said paper upon damping and application to a freshly exposed surface of a fruit forms a barrier limiting exposure of said surface of said fruit to less than 3% oxygen preventing browning of said exposed surface of said fruit.

2. The preservative paper of claim 1, said citric juice and water concentrate consisting essentially of 8 to 10 parts concentrate to 1 part water.

3. The preservative paper of claim 1, said ascorbic acid and water concentrate consisting essentially of 8 to 10 parts concentrate to 1 part water.

4. The preservative paper of claim 1, said preservative paper further including a backing comprising a plastic.

5. The preservative paper of claim 1, said preservative paper including a preservative selected from the group consisting of a sodium bisulfite, and a sodium benzoate.

6. The preservative paper of claim 1, wherein said citric juice concentrate is selected from the group consisting of an orange, a lemon, a lime, a grapefruit, a mandarin, a tangerine and combination thereof.

7. The preservative paper of claim 1 wherein said paper is a coated paper.

8. The preservative paper of claim 1 wherein said paper is an uncoated paper.

9. A method of preserving an exposed surface of fruit with a preservative paper, comprising the steps of:
a) preparing a preservative paper by consisting essentially of the steps of:
selecting a sheet of paper weighting between 20 to 80 pounds
selecting and applying a receiver selected from the group consisting of micro-particles, gelatin, and polymer to said paper;
selecting and applying a barrier selected from the group consisting of polyethylene, cast coating, and a wash coating to said paper;
selecting and applying a base selected from the group consisting of cellulose and a film to said paper;
immersing said paper in citric juice and water concentrate or a citric acid and water concentrate producing a preservative paper;
drying said preservative paper for packaging or storage; and
b) Applying said preservative paper to an exposed portion of a piece of fruit consisting essentially of the steps of:
dampening and moistening said dried preservative paper with water;
applying said moistened preservative paper to said freshly exposed surface of said fruit shaping said preservative paper conforming same to the shape of the exposed portion of said fruit;
re-drying of said moistened preservative paper forming a barrier limiting exposure of said surface of said fruit to less than 3% oxygen preventing browning of said exposed surface.

9. The method of preserving an exposed surface of fruit with a preservative paper of claim 9 including the step of cutting said preservative paper into a selected dimension corresponding to the dimensions of a freshly exposed surface of a fruit.

10. The method of preserving an exposed surface of fruit with a preservative paper of claim 9, wherein said paper includes a backing comprising a plastic.

11. The method of preserving an exposed surface of fruit with a preservative paper of claim 9, wherein said preservative paper includes a preservative selected from the group consisting of a sodium bisulfite, and a sodium benzoate.

12. The method of preserving an exposed surface of fruit with a preservative paper of claim 9 wherein, said citric juice concentrate comprises citric juice in a range of from 8 to 10 parts to 1 part water.

13. The method of preserving an exposed surface of fruit with a preservative paper of claim 9 wherein, said citric juice concentrate comprises ascorbic acid in a range of from 8 to 10 parts to 1 part water.

14. A preservative paper dispenser kit consisting essentially of:
a paper dispenser;
a sheet of acid-free paper weighing between 90 to 150 grams per square meter;
said paper including of a receiver selected from the group consisting of micro-particles, gelatin, or polymer;
said paper including a barrier selected from the group consisting of polyethylene, cast coating, and a wash coating;
said paper including of a base selected from the group consisting of cellulose and a film;
said paper being immersed in a solution containing from 8 to 10 parts concentrate and 1 part water, dried and cut into strips of selected dimensions;
said paper upon damping and application to a freshly exposed surface of a fruit forms a barrier limiting exposure of said surface of said fruit to less than 3% oxygen preventing browning of said exposed surface of said fruit.

15. The preservative paper of claim 14 wherein said paper is a coated paper.

16. The preservative paper of claim 14 wherein said paper is an uncoated paper.

17. The preservative paper of claim 14 further including a preservative selected from the group consisting of sodium sulfite, sodium metabisulfite, and a sodium benzoate.

18. The preservative paper of claim 14, wherein said preservative paper comprises a white brilliance of 84-96.
